(19) United States
(12) Patent Application Publication
(10) Pub. No.: US 2026/0270033 A1
(43) Pub. Date: Sep. 10, 2026

(54) TRANSMISSION CONFIGURATION INDICATOR SWITCHING FOR NON-TERRESTRIAL NETWORK

(71) Applicant: Apple Inc., Cupertino, CA (US)

(72) Inventors: Jie Cui, San Jose, CA (US); Qiming Li, Beijing (CN); Yang Tang, San Jose, CA (US); Chunxuan Ye, San Diego, CA (US); Dawei Zhang, Saratoga, CA (US); Haitong Sun, Saratoga, CA (US)

(73) Assignee: Apple Inc., Cupertino, CA (US)

(21) Appl. No.: 19/165,563

(22) PCT Filed: Mar. 31, 2023
(86) PCT No.: PCT/CN2023/085608

§ 371 Date: Sep. 15, 2025

(51) Int. Cl. H04L 5/00; H04W 8/24; H04W 84/06

(52) U.S. Cl. CPC H04L 5/0098; H04L 5/006; H04L 5/0069; H04W 8/24; H04W 84/06

(57) ABSTRACT

The present application relates to devices and components, including apparatus, systems, and methods for transmission configuration indicator switching for non-terrestrial networks.

### TECHNICAL FIELD

This application generally relates to cellular communication networks and, in particular, to technologies for transmission configuration indicator (TCI) state switching in a non-terrestrial network (NTN).

### BACKGROUND

Third Generation Partnership Project (3GPP) Technical Specifications (TSs) provide details of radio interface protocols to facilitate communication over wireless networks. These TSs define non-terrestrial network (NTN) operation in which a serving cell uses a satellite to communicate with a user equipment (UE). NTN operation may improve coverage, reliability, or data rates. However, further improvements in NTN operation are desired.

### BRIEF DESCRIPTION OF THE DRAWINGS

FIG. 1 illustrates a network environment in accordance with some embodiments

FIG. 2 illustrates a network environment in accordance with some embodiments

FIG. 3 illustrates a network environment in accordance with some embodiments

FIG. 4 illustrates a network environment in accordance with some embodiments

FIG. 5 illustrates an operational flow/algorithmic structure in accordance with some embodiments

FIG. 6 illustrates an operational flow/algorithmic structure in accordance with some embodiments

FIG. 7 illustrates an operational flow/algorithmic structure in accordance with some embodiments

FIG. 8 illustrates an operational flow/algorithmic structure in accordance with some embodiments

FIG. 9 illustrates a user equipment in accordance with some embodiments

FIG. 10 illustrates a network node in accordance with some embodiments

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, or techniques, to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; central processing unit (CPU); graphics processing unit; single-core processor; dual-core processor; triple-core processor; quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any shared entities providing services and may include computing or network resources. System resources may be considered as a set of coherent functions, network data objects, or services accessible through a server where such system resources reside on a single host or multiple hosts and are clearly identifiable.

The terms “multi,” “multiple,” “plurality,” and the like as used herein refer to more than one item, instance, or event.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices to transmit and receive information.

As used herein, the terms “instantiate,” “instantiation,” and the like refer to creating an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

3GPP TSs describe operations that rely on transmission configuration indicator (TCI) states to facilitate communications. A TCI state may define a quasi-co-location (QCL) relationship between a source and a target. The source and target may be reference signals such as, for example, a synchronization signal block (SSB), a channel state information-reference signal (CSI-RS) (for beam management or channel quality indicator (CQI) measurement), a sounding reference signal (SRS), or a demodulation reference signal (DMRS). A source and a target are quasi-co-located when channel properties (for example, spatial, time, or frequency domain properties) determined by the source can also be inferred by the target. Different QCL types indicate different channel properties may be inferred. For example, QCL Type A corresponds to Doppler shift, Doppler Spread, average delay, and delay spread; QCL Type B corresponds to Doppler shift, and Doppler spread; QCL Type C corresponds to Doppler shift and average delay; and QCL Type D corresponds to a spatial Rx parameter.

3GPP Release 17 (R17) introduced a unified TCI framework for single transmit-receive point (TRP) operation. The unified TCI state may refer to a TCI state that applies to multiple downlink or uplink channels. For example, a unified downlink (DL) TCI state may be applied to both a downlink data channel (e.g., a physical downlink shared channel (PDSCH)) and a downlink control channel (e.g., a physical downlink control channel (PDCCH), while a unified uplink (UL) TCI state may be applied to both an uplink data channel (e.g., a PUSCH) and an uplink control channel (e.g., PUCCH). The R17 unified TCI state supports two modes. In a first mode, a joint unified TCI state is applicable to both uplink and downlink channels. In a second mode, a DL TCI state is used for downlink channels, and a separate UL TCI state is used for uplink channels.

To support the two modes of R17, RRC signaling may be used to configure a UE with a pool of unified TCI states by signaling one or two lists. If only one list is used to configure the pool, the list will be a DL-or-joint-TCI-state list (dl-OrJoint-TCIStateList) having TCI states that will be used as joint unified TCI states. If two lists are used to configure the pool, the first list (dl-OrJoint-TCIStateList) will provide unified DL TCI states, and a second list, UL TCI state list (ul-TCI-StateList), will provide unified UL TCI states.

In the R17 unified TCI framework, the TCI states of a configured pool may be indicated/activated in one of two ways. In a first way, a MAC control element (CE) is used to indicate either a joint unified TCI state of the configured pool or to indicate one unified DL TCI state and one unified DL TCI state. In a second way, the MAC CE may activate a plurality of joint unified TCI states or a plurality of sets of unified UL/DL TCI states. Subsequently, DCI may be used to indicate one of the activated TCI/TCI sets that is to be used.

The R17 unified TCI framework that is designed to support a situation in which all uplink and downlink signals/channels are received/transmitted using the same beam (e.g., TCI state). It also provides support for the case in which all downlink signals are received in one beam, and all uplink signals are transmitted in one beam. These limitations of the R17 unified TCI framework inhibit support for multi-TRP (mTRP) operation.

3GPP Release 18 (R18) introduced a framework for the operation of non-terrestrial networks (NTN) in frequency bands above 10 GHz, e.g., Ka-band or FR2 band. The operation of NTN above 10 GHz may allow the satellite to provide denser transmission or reception beams. Embodiments address various issues that may occur from extending the TCI framework to NTN. Some embodiments describe how to switch from one TCI state to another as the satellite moves. These embodiments may describe UE behavior on when and how the UE triggers TCI state switching based on the location of the satellite, how long a TCI state is being activated, or based on UE measurements, e.g., reference signal received power (RSRP) measurements or measuring the changes in altitude or azimuth coordinates of the satellite.

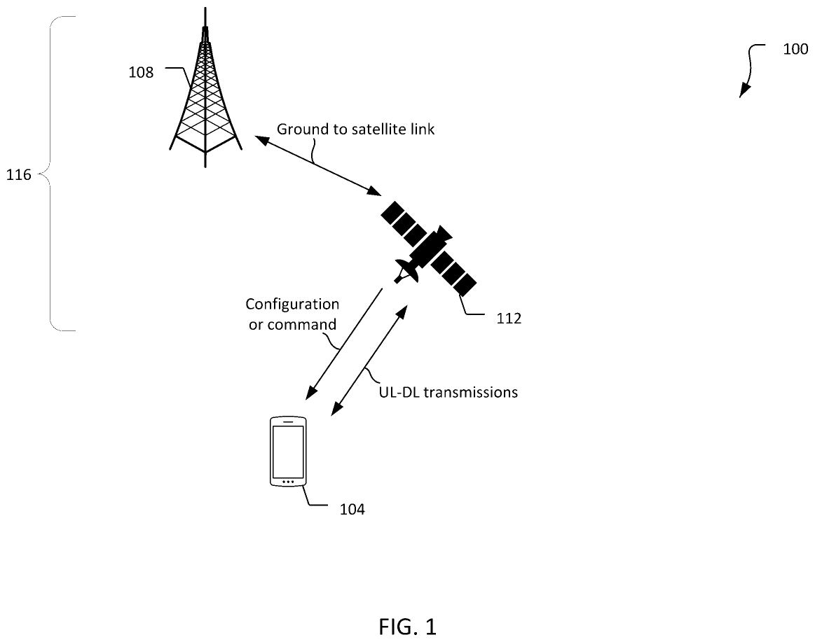

FIG. 1 illustrates a network environment 100 in accordance with some embodiments. The network environment 100 may include a UE 104 and a base station (BS) 108. The BS 108 may be coupled with satellite 112 to provide one or more wireless access cells through which the UE 104 may communicate. While FIG. 1 illustrates the base station 108 coupled with the satellite 112 directly, in other embodiments, more than one base station may be coupled with the satellite 112, and the base stations may communicate with one another over a backhaul link to coordinate communications with the UE 104. The base station 108 and the satellite 112 may be collectively referred to as an access node (AN) 116. The BS 108 may be a ground or terrestrial infrastructure, and the satellite may be the non-terrestrial equipment.

In some embodiment, the access node 116 may be a next-generation node B (gNB) or an ng-NB that provides one or more 3GPP New Radio (NR) cells. The AN 116 may provide the UE 104 access to other networks, for example, a core network, a data network, etc

The satellite 112 may provide an air interface compatible with 3GPP technical specifications, such as those that define Fifth Generation (5G) NR or later system standards. The satellite 112 may be a TRP or a network-controlled relay (NCR). The satellite 112 may be a geostationary orbit (GSO) or non-GSO (NGSO) satellite. Examples of NGSO satellites are low-earth orbit (LEO), mid-earth orbit (MEO), or high-earth orbit (HEO) satellites.

The AN 116 may control the uplink and downlink operation through the physical (PHY) and media access control (MAC) layers. The configuration information may be provided to the UE 104 by a radio resource control (RRC) layer. For example, in a downlink operation, the information is sent from the BS 108 to the satellite 112 via a ground-to-satellite link. The information is then sent to the UE 104 in the DL transmission from the satellite 112. Similarly, in an uplink operation, the information is sent in an uplink transmission from the UE 104 to the satellite 112. The information is then transmitted from the satellite 112 to the BS 108 via the ground-to-satellite link.

The satellite 112 may have multiple transmit (Tx) or receive (Rx) beams. As the satellite moves and its position changes with respect to the UE 104, e.g., when satellite 112 is an NGSO satellite, the Tx or Rx beam for communicating with the UE 104 changes. The TCI state switching mechanism may be implemented in an NTN to adjust the transmission or reception with the communications channel changes caused by the satellite's mobility.

In the legacy terrestrial network, the UE has relatively low mobility as compared to an NTN. The legacy terrestrial network has enough time to train beams, receive and analyze reports from the UE, find the proper TCI, and command the UE to switch to a new TCI. However, in NTN, the satellite moves much faster, and therefore, beam training or finding the best TCI based on the terrestrial networks may not be applicable. A more efficient TCI switching for NTN is desired.

Some embodiments describe the trigger mechanisms for switching the TCI. For example, a timer-based TCI switching may be configured, the AN 116 may send a command to trigger the TCI switching, or the UE 104 may initiate or trigger a TCI switching based on measurement. For example, the UE may measure the signal strength of a target TCI and trigger TCI switching based on the measurement. In another example, the satellite 112 or the BS 108 may configure the UE 104 with timers and thresholds to be used for triggering TCI switching.

Other embodiments describe beam training for an NTN in combination with a TCI switching. For example, based on the triggering method, the Rx beam training may not be needed at the UE 104.

Finally, some embodiments describe mechanisms to improve the TCI switching of legacy networks. The improvement enables improved TCI switching for the legacy networks when deployed in an NTN. For example, the satellite 112 may send a command to instruct the UE 104 to switch TCI based on the satellite's location or a timer.

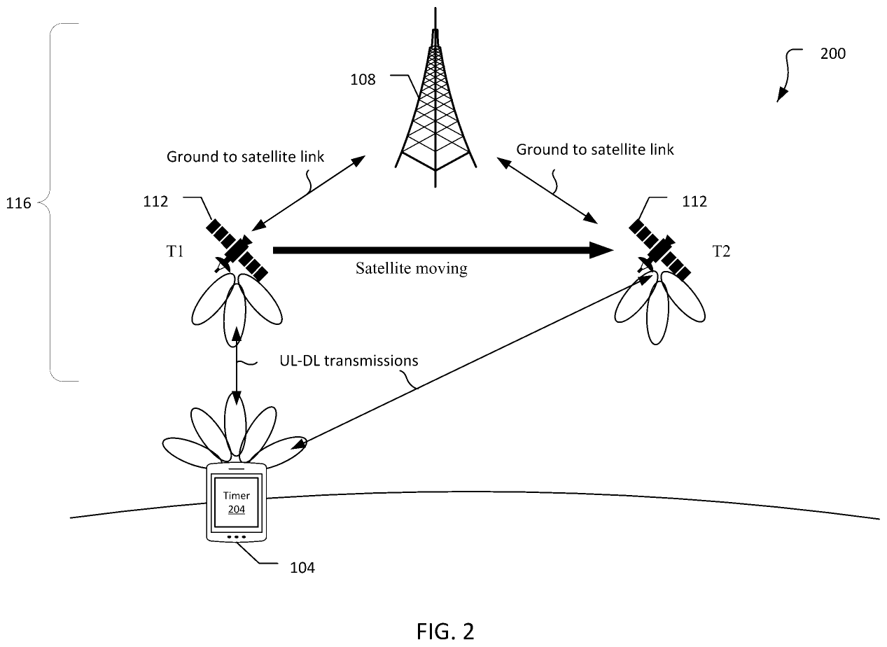

FIG. 2 illustrates a network environment 200 in accordance with some embodiments. The network environment 200 is an example of a system using a timer-based active TCI switching mechanism.

The AN 116 may configure the UE 104 with a list of TCI states. The AN 116 may use RRC signaling for configuring the list of TCI states at the UE 104. The list of TCI states includes one or more TCI states. Each TCI state may include a table that defines the QCL relationship between different reference signals.

The AN 116 may activate a TCI state at the UE 104. The AN 116 may activate a TCI state by sending a message to the UE with an indication of a TCI state in the configured list of TCI states. For example, the AN 116 may send a MAC control element (CE), e.g., TCI state indication MAC CE, that includes a TCI state identification (ID). The ID in MAC CE identifies the TCI state, and UE 104 activates the identified TCI. The TCI state may be associated with a serving cell. For example, different serving cells may have different TCI states. The TCI state may be a DL TCI state, an UL TCI state, or a unified TCI state.

The AN 116 may activate a TCI state using a downlink (DL) control information (DCI). For example, the DCI may include a TCI state ID that identifies a TCI state in the configured list of TCI states. The UE activates the identified TCI state on the serving cell that is explicitly or implicitly associated with the DCI. A serving cell may be implicitly associated with a DCI based on the serving cell on which the DCI is received. A serving cell may be explicitly associated with a DCI when the DCI includes the associated cell ID.

The UE 104 may activate a TCI state based on detecting a condition. For example, based on the amount of time that the current TCI state is being activated, the UE may switch and activate another TCI state.

The AN 116 may configure a timer 204, a TCI timer, at the UE 104. The timer 204 may have a duration, e.g., D seconds. The timer 204 may be associated with a TCI state. When the UE 104 activates a TCI state (current TCI state or the active TCI), the UE 104 starts the timer 204. The UE 104 may create an instance of the configured timer 204 for a TCI state. The AN 116 may configure one timer for the UE 104 used for all TCI states or one timer for each TCI state in the list of TCI states. The timer duration may be the same for all the timers associated with all TCI states, or each TCI state may have a timer with a duration that is different than or independent from the durations of the timers of other TCI states. The AN 116 may configure a timer for a TCI state associated with a channel. For example, a timer for a TCI state associated with a physical downlink control channel (PDCCH) or another timer for a TCI state associated with the physical downlink shared channel (PDSCH). The timer may be associated with a cell, a component carrier, or a TRP. The timer may be associated with other physical channels, e.g., physical broadcast channel, physical random access channel, physical uplink control channel, or physical uplink shared channel

The UE 104 or the AN 116 may terminate, stop, or end the timer 204. For example, the UE 104 or the AN 116 may stop the timer 204 when the active TCI associated with the timer 204 is deactivated or disabled. The UE 104 or the AN 116 may deactivate or disable an active TCI. The AN 116 may deactivate or disable an active TCI by sending a command or configuration to the UE 104, e.g., an RRC reconfiguration or a MAC CE deactivation or disabling command. The UE 104 or the AN 116 may stop the timer 204 associated with a serving cell when there is a cell change, e.g., a handover to another cell. The UE 104 or the AN 116 may stop the timer 204 associated with a TCI state when the UE has a beam failure on a beam used for a transmission associated with the TCI. The UE 104 or the AN 116 may stop the timer 204 when a radio link failure (RLF) on the cell or component carrier associated with the TCI state is detected. For example, the UE 104 may detect an RLF on a cell and stop a timer of a TCI state associated with that cell.

The timer 204 may run for its configured duration and expire. When the timer 204 expires, the UE 104 may switch to a target TCI state. In one instance, the AN 116 may indicate the target TCI state before the expiration of the timer 204. For example, the AN 116 may indicate the target TCI via RRC, MAC CE, or DCI messages. In another instance, the UE 104 may identify the target TCI state. For example, the UE 104 may perform a measurement, e.g., an RSRP measurement, of TCI states from candidate TCI states and choose or select the best TCI in the candidate list as the target TCI. The candidate TCI states may be a subset of the list of configured TCI states or a set of TCI states independent from the list of configured TCI states. The AN 116 may configure or indicate the candidate TCI states.

Switching TCI state may include timing-frequency offset tracking on the reference signal (RS) associated with the target TCI or Rx beam training on RS associated with the target TCI state. The Rx beam training may include layer 1 (L1) RSRP training.

Before or after switching, the UE 104 may indicate the target TCI state to the network. The UE may indicate the target TCI to the network by including the TCI state ID in an RRC, MAC CE, or uplink control information (UCI) message.

The AN 116 may have an instance of the timer 204. For example, when a TCI state is activated at the UE 104, the AN 116 may also instantiate a timer with the same configuration as the timer 204 and associate it with the UE's TCI state. The AN 116 may track the timer 204 locally and expect a TCI state switching and receiving the UE's new TCI state upon expiration of the timer. When the network preconfigures the target TCI, the AN 116 can track the expiration of the timer 204 and has the information of the target TCI state. Therefore, the AN 116 may use the target TCI for communicating with the UE.

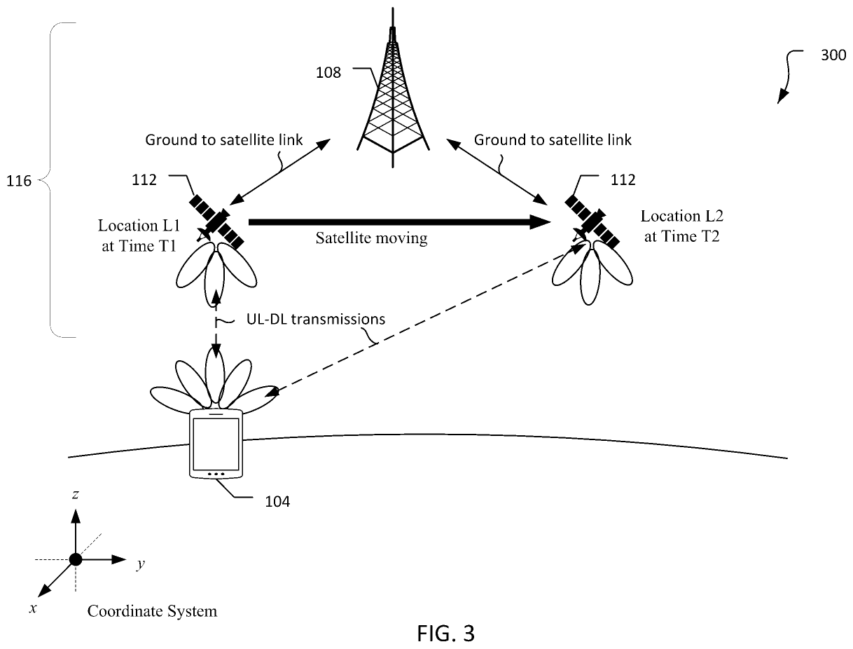

FIG. 3 illustrates a network environment 300 in accordance with some embodiments. The network environment 300 is an example of a system using a UE-triggered TCI state switching mechanism.

In the legacy terrestrial networks (TN), the network triggers TCI switching. For example, the network sends an indication of the target TCI state, e.g., the ID of the target TCI state, via an RRC, MAC CE, or DCI message.

In some embodiments, the UE 104 may trigger the TCI state switching directly based on its own decision. The UE 104 may be configured with a list of candidate TCI states. The UE 104 selects the target TCI state from a list of candidate TCI states based on a search criteria. The UE 104 may indicate the new TCI state to the network. The selection criteria may be configured by the network, specified in a 3GPP TS, or a UE implementation. The UE 104 may trigger the TCI state switching according to one or more of the following options.

In a first option, the UE 104 triggers the TCI state switching based on a DL measurement, e.g., an RSRP measurement, without a report. The UE measures the RS associated with the current TCI state or the RS associated with the target TCI state. The UE 104 may trigger switching to the target TCI state when the target TCI state RS measurement meets a certain condition, or the current TCI state RS meets a certain condition. For example, the UE 104 may trigger switching the TCI state when the RSRP of the RS of the current TCI state is smaller than a preconfigured threshold or the RSRP of the RS of the target TCI state is greater than another preconfigured threshold. The thresholds may be defined in 3GPP TSs or configured by the network, e.g., via RRC signaling or MAC CE.

The UE 104 may indicate the TCI state switching or the new TCI state to the access node 116. For example, the UE 104 may indicate the new TCI to the network using the old UL channel before TCI switching or may use a random access channel (RACH) after TCI state switching.

In a second option, the UE 104 may trigger the TCI state switching based on the altitude or azimuth change of the satellite 112. The UE 104 location information may not be available to the AN 116. However, the satellite 112 location information, e.g., ephemeris information, is available to the UE through system information block (SIB) or broadcast system information. The UE 104 may also have information about its own location. For example, the UE 104 may have its location information through global satellite positioning (GPS) or the global navigation satellite system (GNSS). Therefore, the UE 104 may calculate the location information, e.g., the altitude or azimuth angle, of the satellite 112.

The UE 104 may use a coordinate system to calculate the location of the satellite 112. For example, the UE 104 may use the Cartesian coordinate (x, y, z) or the spherical coordinate (ρ, θ, φ) where ρ is the radial distance, θ is the polar angle, and φ is the azimuthal angle.

The UE 104 may measure the location information of the satellite 112 when activating the current TCI state. The UE 104 may monitor the changes in the location information of the satellite 112. The UE 104 may trigger switching the TCI state when the changes in the location information of the satellite 112 meet certain criteria. For example, the UE 104 may trigger switching the TCI state when the altitude or azimuth angle changes are greater than a preconfigured threshold. The threshold may be defined in 3GPP TSs or configured by the network, e.g., via RRC signaling or MAC CE.

The UE 104 may identify and select the target TCI state based on a network-preconfigured list or based on its own measurement. In one instance, the AN 116 may indicate the target TCI state. For example, the AN 116 may indicate the target TCI via RRC, MAC CE, or DCI messages. In another instance, the UE may identify the target TCI state based on its own measurement. For example, the UE 104 may perform a measurement, e.g., RSRP measurement, of TCI states from the list of candidate TCI states and choose or select the best TCI in the candidate list as the target TCI.

The UE 104 may indicate the TCI state switching or the new TCI state to the access node 116. For example, the UE 104 may indicate the new TCI to the network using the old UL channel before TCI switching or may use a random access channel (RACH) after TCI state switching.

In a third option, the UE 104 may trigger the TCI state switching based on a timestamp. The AN 116 may configure the UE 104 with a list of TCI states. Each TCI state in the list of TCI states is associated with a timestamp. The UE 104 may switch to the target TCI state at the associated timestamp, e.g., complete switching to the target TCI at the timestamp, or the UE 104 may start to switch to the target TCI state at the associated timestamp. For example, the UE 104 is configured with TCI state 1 associated with timestamp T1 and TCI state 2 associated with timestamp T2. The UE 104 may use TCI state 1 at time T1 and TCI state 2 at time T2.

The timestamp may be an absolute timing, e.g., GNSS clock timing. The timestamp may be epoch timing associated with ephemeris information of the satellite 112. The timestamp may be the subframe number or slot index of the serving or target cell.

TCI state switching at the UE 104 may take some time. The time needed to complete the TCI state switching procedure is called the TCI state switching delay. For example, if the UE 104 initiates TCI state switching at time T, the UE 104 may be able to transmit or receive information with the target TCI at T+delay, where delay is the TCI state switching delay. The UE 104 may use the old TCI between time T and T+delay.

In the example above, the UE 104 may start switching to TCI state 1 at timestamp T1. The TCI state switching may be completed at time T1+delay. The UE 104 may start switching to TCI state 2 at timestamp T2. If T2−T1 is smaller than delay, it means that the UE 104 has to initiate TCI state switching to TCI state 2 before completing the TCI state switching to TCI state 1. In this situation, the UE 104 may keep the old TCI state and not change the TCI or switch to the new TCI state, e.g., TCI state 1 at T1+delay, and inform the network of delay or failure. The UE 104 may inform the network using the UE capabilities list message about the value of delay to assist the AN 116 in designing a feasible TCI state switching at proper timestamps.

The UE 104 may indicate the TCI state switching or the new TCI state to the access node 116. For example, the UE 104 may indicate the new TCI to the network using the old UL channel before TCI switching or may use a random access channel (RACH) after TCI state switching.

In a fourth option, the UE 104 may trigger the TCI state switching based on the position of the satellite 112. The AN 116 may configure the UE 104 with a list of TCI states. Each TCI state in the list of TCI states is associated with a position. The UE 104 may switch to the target TCI state at the associated position, e.g., complete switching to the target TCI when the satellite is at the associated position, or the UE 104 may start to switch to the target TCI state at the associated position. For example, the UE 104 is configured with TCI state 1 associated with the satellite 112 location L1 and TCI state 2 associated with the satellite 112 location L2. The UE 104 may use TCI state 1 when satellite 112 is at L1 and TCI state 2 when satellite 112 is at L2. The position or location of the satellite may be in the same format as ephemeris information.

The UE 104 may indicate the TCI state switching or the new TCI state to the access node 116. For example, the UE 104 may indicate the new TCI to the network using the old UL channel before TCI switching or may use a random access channel (RACH) after TCI state switching.

The UE 104 may implement all or some of the options above. The UE 104 may inform the network via UE capability information of the implemented options. The network, e.g., the AN 116, may configure the UE 104 to use one of the options for triggering TCI state switching.

In another embodiment, the network environment 300 may be an example of a system using enhancement on the network triggering active TCI switching. In the legacy TCI state switching, the network may send a command to UE with a TCI state ID.

The network may indicate the UE 104 to switch to a new TCI state with a timestamp. For example, the network may indicate the UE 104 to switch or start switching to a target TCI state at time T1. The timestamp can be absolute timing, e.g., GNSS clock, epoch timing associated with ephemeris information of the satellite 112, or the subframe number or slot index of the target cell.

The network may indicate the UE 104 is to switch to a new TCI state with a position stamp. For example, the network may indicate the UE 104 is to switch or start switching to a target TCI state when the satellite 112 is at position L1.

The network may indicate the timestamp or the position stamp to the UE 104 using RRC, MAC CE, or DCI messages.

Suppose that the UE 104 receives commands at T1 to switch TCI state with an associated timestamp of T2. Further, suppose that the switching delay takes a period of time denoted by delay. If T1+delay is greater than T2, it means that the UE 104 may not be able to complete switching TCI state at T2. This may be an error state or a failure. The UE 104, in response to this error condition, keep the old TCI or switch to the new TCI state after T2, e.g., at T1+delay, and indicate such delay or failure to the network.

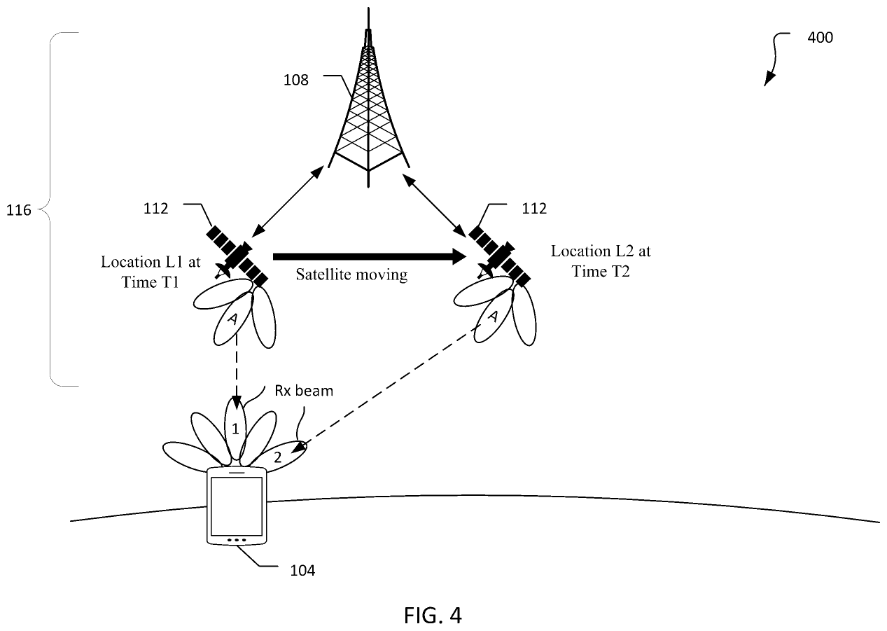

FIG. 4 illustrates a network environment 400 in accordance with some embodiments. The network environment 400 is an example of a system using an Rx beam calculation.

The UE 104 may measure the RS associated with the target TCI state at time T1. At time T1, the UE 104 may use beam 1 for receiving the signals transmitted from beam A of the satellite 112. The UE 104 may perform beam sweeping to identify the Rx beam. For example, the UE 104 may identify beam 1 as the Rx beam. Suppose that the UE 104 is required to switch to target TCI at time T2. At time T2, the time is beyond the time threshold of known TCI state condition, e.g., T2−T1 is greater than 1280 ms.

In one instance, the UE 104 may perform beam sweeping to identify the Rx beam. For example, the UE 104 at T2 may identify beam 2 to be the Rx beam. In another instance, the UE 104 may use the satellite location L1 at T1 and satellite location L2 at T2 to identify the Rx beam at time T2. When computing the Rx beam at time T2, beam sweeping, and L1 RSRP measurement can be skipped.

The UE 104 may inform the AN 116 about TCI state switching with or without L1 RSRP measurement. Skipping the L1 RSRP measurement may reduce the TCI state switching delay.

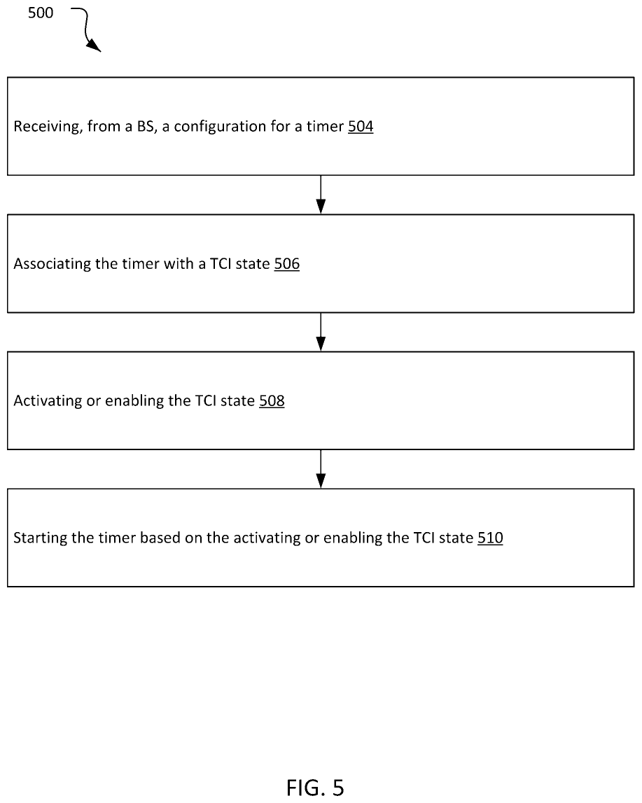

FIG. 5 illustrates an operational flow/algorithmic structure 500 in accordance with some embodiments. Operational flow/algorithmic structure 500 is an example of operating a UE to provide timer-based active TCI state switching. The operational flow/algorithmic structure 500 may be implemented by a UE, for example, the UE 104, the UE 900, or components therein, e.g., processors 904.

The operational flow/algorithmic structure 500 may include, at 504, receiving, from a BS, a configuration for a timer. The configuration may be included in an RRC, MAC CE, or DCI message.

The operational flow/algorithmic structure 500 may include, at 506, associating the timer with a TCI state. The timer is associated with UE's active TCI state in UL or DL transmission. The TCI may be an UL TCI, a DL TCI, or a unified TCI.

The operational flow/algorithmic structure 500 may include, at 508, activating or enabling the TCI state. The UE may receive a command, e.g., in an RRC, MAC CE, or DCI, to activate or enable the TCI state associated with the timer. The UE may receive TCI state configurations and not be supported by a network. The network may disable those TCI state configurations. Once the UE connects with a network that supports those TCI states, the UE may receive a command to enable those features. In some instances, the network may instruct to apply a TCI state configuration and sends a command to the UE to activate that TCI state.

The operational flow/algorithmic structure 500 may include, at 510, starting the timer based on activating or enabling the TCI state. The UE starts the timer based on receiving the activation command or once the TCI state is activated.

The UE may trigger a TCI state-switching procedure when the timer is expired. The UE selects a TCI state from the list of candidate TCI states and activates the new TCI state.

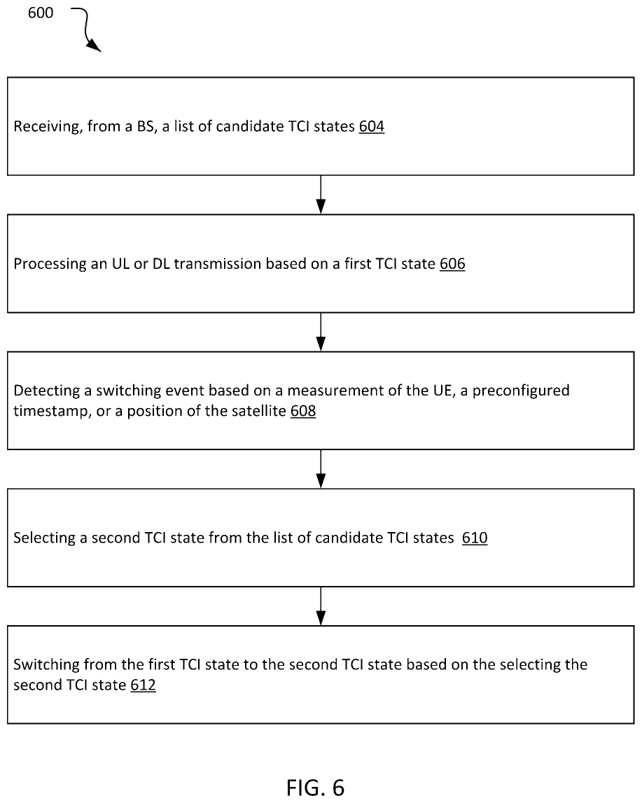

FIG. 6 illustrates an operational flow/algorithmic structure 600 in accordance with some embodiments. Operational flow/algorithmic structure 600 is an example of operating a UE to provide UE-triggered TCI state switching. The operational flow/algorithmic structure 600 may be implemented by a UE, for example, the UE 104, the UE 900, or components therein, e.g., processors 904.

The operational flow/algorithmic structure 600 may include, at 604, receiving, from a BS, a list of candidate TCI states. The UE may receive the list via RRC signaling or MAC CE.

The operational flow/algorithmic structure 600 may include, at 606, processing an UL or DL transmission based on a first TCI state.

The operational flow/algorithmic structure 600 may include, at 608, detecting a switching event based on a measurement of the UE, a preconfigured timestamp, or a position of the satellite. The switching event is when the first RSRP measurement associated with the first TCI state is smaller than a first RSRP threshold. The switching event is when the second RSRP measurement associated with the second TCI state is greater than a second RSRP threshold. The switching event is when the altitude change associated with the satellite is greater than an altitude change threshold. The switching event is when the azimuth change associated with the satellite is greater than an azimuth change threshold.

The operational flow/algorithmic structure 600 may include, at 610, selecting a second TCI state from the list of candidate TCI states based on detecting the switching event. The second TCI may be configured by the network, or the UE may determine the second TCI based on measurement.

The operational flow/algorithmic structure 600 may include, at 612, switching from the first TCI state to the second TCI state based on selecting the second TCI state. The UE may report the second TCI to the network.

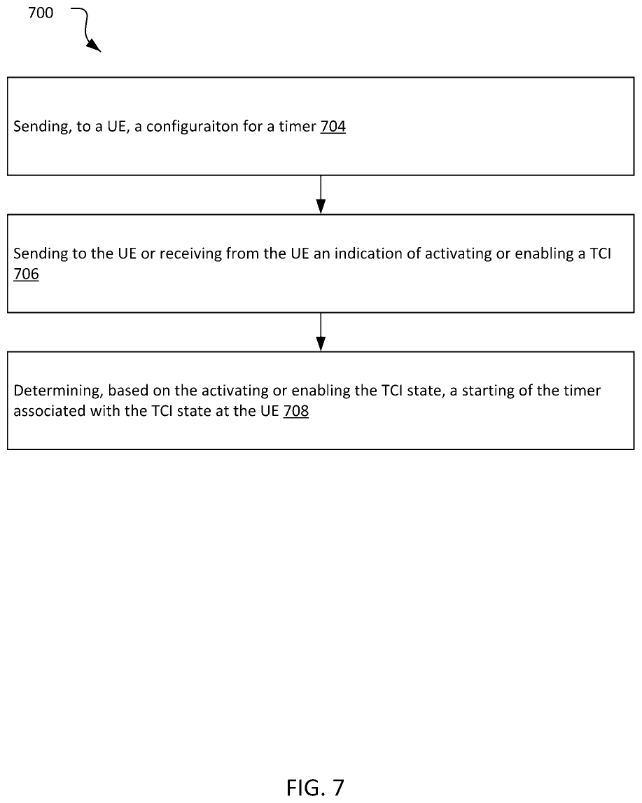

FIG. 7 illustrates an operational flow/algorithmic structure 700 in accordance with some embodiments. Operational flow/algorithmic structure 700 is an example of operating a BS to provide a timer configuration to a UE to perform TCI state switching. The operational flow/algorithmic structure 700 may be implemented by a BS, for example, the BS 108, the BS 1000, or components therein, e.g., processors 1004.

The operational flow/algorithmic structure 700 may include, at 704, sending, to a UE, a configuration for a timer. The timer is associated with a TCI state, a channel, a component carrier, or a cell. Each TCI state may have its own timer or timer duration.

The operational flow/algorithmic structure 700 may include, at 706, sending to the UE or receiving from the UE an indication of activating or enabling a TCI. The UE may receive an activation command from the AN, or the UE may activate a TCI state based on a triggering event or condition at the UE in which the UE may send an indication of activating or enabling a TCI state.

The operational flow/algorithmic structure 700 may include, at 708, determining, based on the activating or enabling the TCI state, a starting of the timer associated with the TCI state at the UE. The BS may have a timer that tracks the timer associated with the activated TCI at the UE.

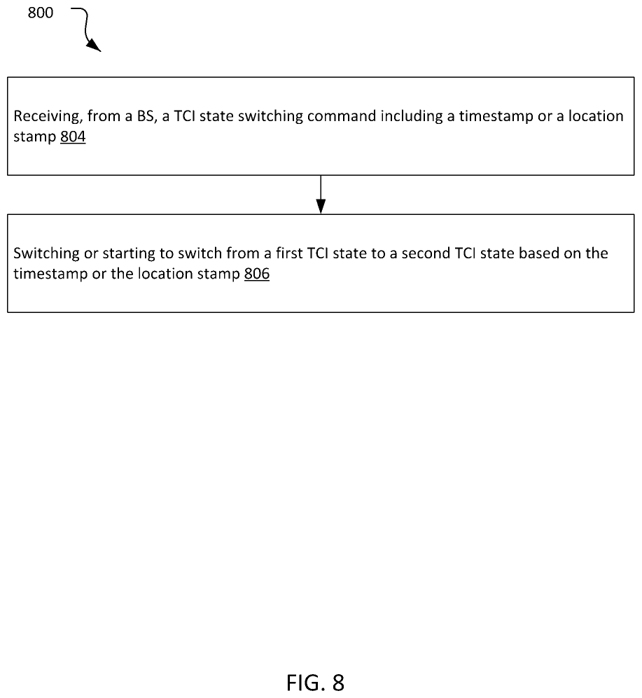

FIG. 8 illustrates an operational flow/algorithmic structure 800 in accordance with some embodiments. Operational flow/algorithmic structure 800 is an example of operating a UE to provide enhancements to legacy TCI state switching. The operational flow/algorithmic structure 800 may be implemented by a UE, for example, the UE 104, the UE 900, or components therein, e.g., processors 904.

The operational flow/algorithmic structure 800 may include, at 804, receiving, from a BS, a TCI state switching command, including a timestamp or a location stamp. The command may instruct the UE to switch the TCI state to an indicated target TCI state at a specified time or when the satellite is at the specified location.

The operational flow/algorithmic structure 800 may include, at 806, switching or starting to switch from a first TCI state to a second TCI state based on the timestamp or the location stamp.

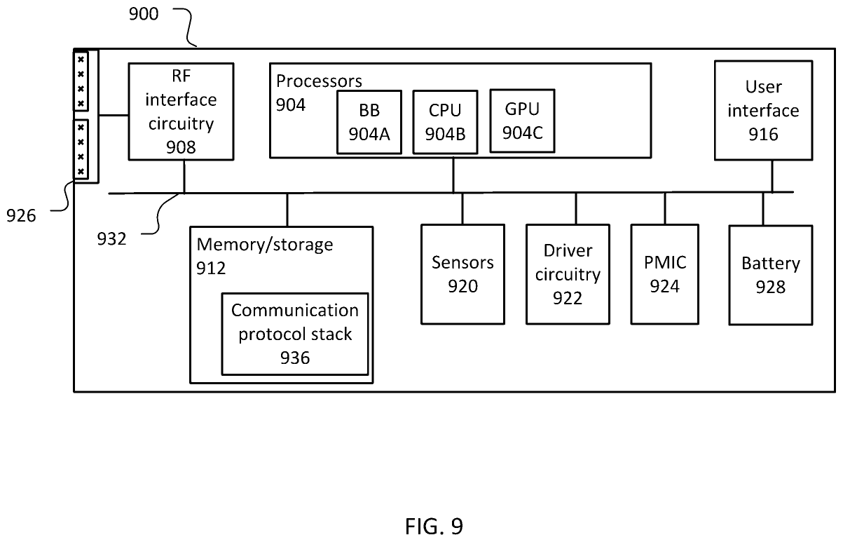

FIG. 9 illustrates a UE 900 in accordance with some embodiments. The UE 900 may be similar to and substantially interchangeable with UE 104 of FIG. 1.

The UE 900 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

The processors 904 may perform operations associated with performing timer-based or trigger-based TCI state switching. For example, the processors 904 may receive configurations of a timer and triggers TCI state switching mechanism when the timer is expired consistent with embodiments described herein.

In some embodiments, the baseband processor circuitry 904A may access a communication protocol stack 936 in the memory/storage 912 to communicate over a 3GPP-compatible network. In general, the baseband processor circuitry 904A may access the communication protocol stack 936 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 912 may include one or more non-transitory, computer-readable media that includes instructions (for example, the communication protocol stack 936) that may be executed by one or more of the processors 904 to cause the UE 900 to perform various operations described herein. The memory/storage 912 includes any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processor 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands, including bands in FR1 or FR2.

The user interface circuitry 916 includes various input/output (I/O) devices designed to enable user interaction with the UE 900. The user interface 916 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various I/O devices that may be present within or connected to the UE 900. For example, the driver circuitry 922 may include circuitry to facilitate the coupling of a universal integrated circuit card (UICC) or a universal subscriber identity module (USIM) to the UE 900. For additional examples, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage the power provided to various components of the UE 900. In particular, with respect to the processors 904, the PMIC 924 may control power-source selection, voltage scaling, battery charging, or DC-to-DC conversion.

In some embodiments, the PMIC 924 may control or otherwise be part of various power-saving mechanisms of the UE 900, including DRX, as discussed herein.

A battery 928 may power the UE 900, although in some examples, the UE 900 may be mounted and deployed in a fixed location and may have a power supply coupled to an electrical grid. The battery 928 may be a lithium-ion battery, a metal-air battery, such as a zinc-air battery, an aluminum-air battery, a lithium-air battery, and the like. In some implementations, such as in vehicle-based applications, the battery 928 may be a typical lead-acid automotive battery.

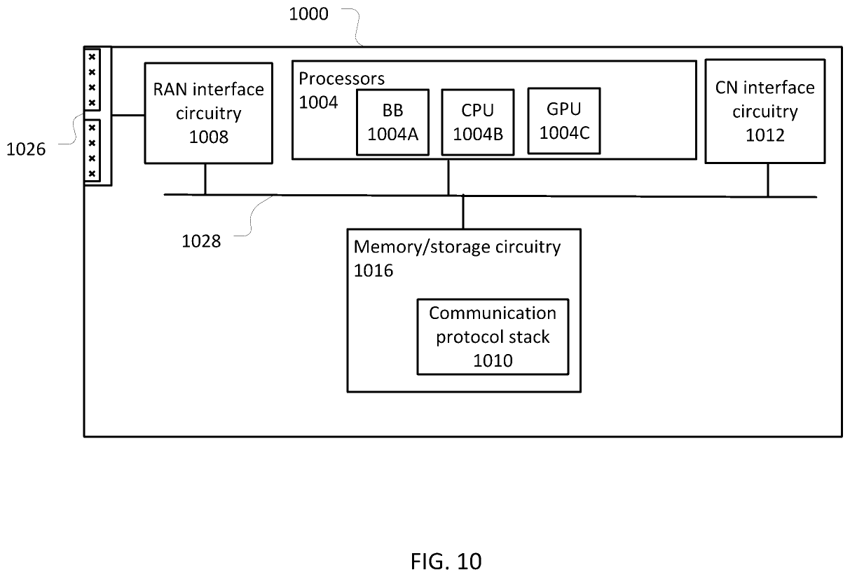

FIG. 10 illustrates a network node 1000 in accordance with some embodiments. The network node 1000 may be similar to and substantially interchangeable with base station 108, a device implementing one of the network hops, an integrated access and backhaul (IAB) node, a network-controlled repeater, or a server in a core network or external data network.

The network node 1000 may include processors 1004, RF interface circuitry 1008 (if implemented as an access node), the core node (CN) interface circuitry 1012, memory/storage circuitry 1016, and antenna structure 1026.

The components of the network node 1000 may be coupled with various other components over one or more interconnects 1028.

The processors 1004, RF interface circuitry 1008, memory/storage circuitry 1016 (including communication protocol stack 1010), antenna structure 1026, and interconnects 1028 may be similar to like-named elements shown and described with respect to FIG. 9.

The processors 1004 may perform operations associated with enabling a UE to trigger TCI state switching in a NTN. For example, the processors 1004 may configure the UE with a timer that triggers a TCI state switching mechanism at the UE upon expiration of the timer and consistent with embodiments described herein.

The CN interface circuitry 1012 may provide connectivity to a core network, for example, a 5th Generation Core network (5GC) using a 5GC-compatible network interface protocol such as carrier Ethernet protocols or some other suitable protocol. Network connectivity may be provided to/from the network node 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some embodiments, the network node 1000 may be coupled with transmit-receive points (TRPs) using the antenna structure 1026, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method of operating a user equipment (UE), the method including: receiving, from a base station (BS), a configuration for a timer; associating the timer with a transmission configuration indicator (TCI) state; activating or enabling the TCI state; and starting the timer based on said activating or enabling the TCI state.

Example 2 includes the method of example 1 or some other examples herein, further including: receiving a medium access control (MAC) control element (CE) or a downlink control information (DCI) message, including an activation or enabling indication; and activating or enabling the TCI state based on the activation or enabling indication.

Example 3 includes the method of examples 1 or 2 or some other examples herein, wherein the TCI state is a downlink TCI state, an uplink TCI state, or a unified TCI state.

Example 4 includes the method of any of examples 1-3 or some other examples herein, wherein the timer is associated with the UE, a physical downlink control channel, a physical downlink shared channel, a component carrier, a cell, or a transmission point.

Example 5 includes the method of any of examples 1-4 or some other examples herein, further including: receiving an indication of a deactivation or disabling, a handover to another cell, a beam failure, or a radio link failure: and ending or terminating the timer based on the indication.

Example 6 includes the method of any of examples 1-5 or some other examples herein, wherein the TCI state is a first TCI state, and the method further includes: receiving, from the BS, a list of candidate TCI states; selecting a second TCI state from the list of candidate TCI states; and switching to the second TCI state based on an expiration of the timer.

Example 7 includes the method of any of examples 1-6 or some other examples herein, wherein said selecting a second TCI state is based on: a configuration provided by a radio resource control message, a medium access control control element message, or a downlink control information message; or a measurement, by the UE, of the first or second TCI states.

Example 8 includes the method of any of examples 1-7 or some other examples herein, further including: tracking a timing offset or a frequency offset of a first reference signal associated with the second TCI state; or training a receive beam based on a second reference signal associated with the second TCI state.

Example 9 includes a method of operating a user equipment (UE), the method including: receiving, from a base station (BS) coupled with a satellite, a list of candidate transmission configuration indicator (TCI) states; processing an uplink or downlink transmission based on a first TCI state; detecting a switching event based on a measurement of the UE, a preconfigured timestamp, or a position of the satellite; selecting a second TCI state from the list of candidate TCI states; and switching from the first TCI state to the second TCI state based on said selecting the second TCI state.

Example 10 includes the method of example 9 or some other examples herein, wherein the measurement of the UE includes a first reference signal received power (RSRP) measurement associated with the first TCI state, a second RSRP measurement associated with the second TCI state, an altitude change measurement associated with the satellite, or an azimuth change measurement associated with the satellite.

Example 11 includes the method of examples 9 or 10 or some other examples herein, wherein said detecting a switching event includes detecting: a first RSRP measurement associated with the first TCI state is smaller than a first RSRP threshold; a second RSRP measurement associated with the second TCI state is greater than a second RSRP threshold; an altitude change associated with the satellite is greater than an altitude change threshold; or an azimuth change associated with the satellite is greater than an azimuth change threshold.

Example 12 includes the method of any of examples 9-11 or some other examples herein, further including: reporting, to the BS, the second TCI state.

Example 13 includes the method of any of examples 9-12 or some other examples herein, wherein the switching event is based on a preconfigured timestamp, and the preconfigured timestamp is an absolute timing associated with a clock, an epoch timing associated with an ephemeris information of the satellite, or a subframe number or a slot index of a cell associated with the second TCI state.

Example 14 includes the method of any of examples 9-13 or some other examples herein, wherein the switching event is based on a position of the satellite.

Example 15 includes the method of any of examples 9-14 or some other examples herein, further including: receiving, from the BS, the position of the satellite; or compute the position of the satellite based on a location of the UE and ephemeris information of the satellite.

Example 16 includes the method of any of examples 9-15 or some other examples herein, further including: determining a receive beam at the UE based on the position of the satellite.

Example 17 includes a method of operating a base station (BS), the method including: sending, to a user equipment (UE), a configuration for a timer; sending to the UE or receiving from the UE an indication of activating or enabling a transmission configuration indicator (TCI) state; and determining, based on said activating or enabling the TCI state, a starting of the timer associated with the TCI state at the UE.

Example 18 includes the method of example 17 or some other examples herein, wherein the TCI state is a downlink TCI state, an uplink TCI state, or a unified TCI state.

Example 19 includes the method of examples 17 or 18 or some other examples herein, wherein the timer is associated with the TCI state, the UE, a physical downlink control channel, a physical downlink shared channel, a physical broadcast channel, a physical random access channel, a physical uplink control channel, a physical uplink shared channe, a component carrier, a cell, or a transmission point.

Example 20 includes the method of any of examples 17-19 or some other examples herein, wherein the TCI state is a first TCI state, and the method further including: sending, to the UE, a list of candidate TCI states; selecting a second TCI state from the list of candidate TCI states based on a configuration or an indication; and switching from the first TCI state to the second TCI state based on said selecting a second TCI state.

Example 21 includes the method of any of examples 17-20 or some other examples herein, further including: receiving, from the UE, the indication of the second TCI state.

Example 22 includes the method of any of examples 17-21 or some other examples herein, further including: sending, to the UE, a reference signal associated with the second TCI state.

Example 23 includes the method of any of examples 17-22 or some other examples herein, further including: receiving, from the UE, a UE capability message to indicate whether the UE is capable of switching the TCI state without a measurement of layer 1 (L1) reference signal received power (RSRP).

Example 24 includes a method of operating a user equipment (UE), the method including: receiving, from a base station (BS), a command including a timestamp or a location stamp; switching or starting to switch from a first transmission configuration indicator (TCI) state to a second TCI state based on the timestamp or the location stamp.

Example 25 includes the method of example 24 or some other examples herein, wherein a period of time is a time difference between a first time at which the UE is to receive the command and a second time at which the UE is to complete switching to the second TCI state, and the method further including: determining that the period of time is larger than a threshold; and switching to the first TCI state, or sending to the BS an indication of the period of time.

Another example may include an apparatus comprising logic, modules, or circuitry to perform one or more elements of a method described in or related to any of examples 1-25, or any other method or process described herein.

Another example may include a method, technique, or process as described in or related to any of examples 1-25, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-25, or portions thereof.

Another example includes a signal as described in or related to any of examples 1-25, or portions or parts thereof.

Another example may include a datagram, information element, packet, frame, segment, PDU, or message as described in or related to any of examples 1-25, or portions or parts thereof, or otherwise described in the present disclosure.

Another example may include a signal encoded with data as described in or related to any of examples 1-25, or portions or parts thereof, or otherwise described in the present disclosure.

Another example may include a signal encoded with a datagram, IE, packet, frame, segment, PDU, or message as described in or related to any of examples 1-25, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-25, or portions thereof.

Another example may include a computer program comprising instructions, wherein execution of the program by a processing element is to cause the processing element to carry out the method, techniques, or process as described in or related to any of examples 1-25, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1-27. (canceled)

28. A method comprising:
receiving, from a base station (BS), a configuration for a timer associated with transmission configuration indicator (TCI) state switching;
activating or enabling a TCI state; and
starting the timer based on said activating or enabling the TCI state.

29. The method of claim 28, further comprising:
receiving a medium access control (MAC) control element (CE) or a downlink control information (DCI) message including an activation or enabling indication; and
activating or enabling the TCI state based on the activation or enabling indication.

30. The method of claim 28, wherein the timer is further associated with a user equipment (UE), a physical channel, a component carrier, a cell, or a transmission point.

31. The method of claim 28, further comprising terminating the timer based on:
the TCI state being deactivated or disabled;
a handover to another cell;
a beam failure; or
a radio link failure.

32. The method of claim 28, wherein the TCI state is a first TCI state and the method further comprises switching to a second TCI state based on expiration of the timer.

33. The method of claim 32, further comprising:
receiving, from the BS, a list of candidate TCI states;
selecting the second TCI state from the list of candidate TCI states; and
generating, for transmission to the BS, an indication of the second TCI.

34. The method of claim 33, wherein said selecting the second TCI state is based on:
a configuration provided by a radio resource control (RRC) message, a medium access control (MAC) control element (CE) message, or a downlink control information (DCI) message; or
a measurement associated with the first or second TCI states.

35. The method of claim 34, further comprising:
tracking a timing offset or a frequency offset of a first reference signal associated with the second TCI state; or
training a receive beam based on a second reference signal associated with the second TCI state.

36. An apparatus comprising:
processor circuitry to:
receive, from a base station (BS) coupled with a satellite, a list of candidate transmission configuration indicator (TCI) states;
process an uplink or downlink transmission based on a first TCI state;
detect a switching event based on a measurement of a user equipment (UE), a preconfigured timestamp, or a position of the satellite; and
switch from the first TCI state to a second TCI state based on the detection of the switching event, the second TCI state selected from the list of candidate TCI states; and interface circuitry coupled to the processor circuitry to enable communication.

37. The apparatus of claim 36, wherein the measurement of the UE includes a first reference signal received power (RSRP) measurement associated with the first TCI state, a second RSRP measurement associated with the second TCI state, an altitude change measurement associated with the satellite, or an azimuth change measurement associated with the satellite.

38. The apparatus of claim 37, wherein to detect the switching event comprises to detect that:
the first RSRP measurement associated with the first TCI state is smaller than a first RSRP threshold;
the second RSRP measurement associated with the second TCI state is greater than a second RSRP threshold;
the altitude change associated with the satellite is greater than an altitude change threshold; or
the azimuth change associated with the satellite is greater than an azimuth change threshold.

39. The apparatus of claim 36, wherein the processor circuitry is further to generate, for transmission to the BS, an indication of the second TCI state.

40. The apparatus of claim 36, wherein the switching event is based on the preconfigured timestamp, and the preconfigured timestamp is an absolute timing associated with a clock, an epoch timing associated with an ephemeris information of the satellite, or a subframe number or a slot index of a cell associated with the second TCI state.

41. The apparatus of claim 36, wherein the switching event is based on the position of the satellite.

42. The apparatus of claim 41, wherein the processor circuitry is further to:
receive, from the BS, the position of the satellite; or
compute the position of the satellite based on a location of the UE and ephemeris information of the satellite.

43. The apparatus of claim 42, wherein the processor circuitry is further to determine a receive beam for the UE based on the position of the satellite.

44. One or more non-transitory, computer-readable media having instructions that, when executed, cause processor circuitry to:
generate, for transmission to a user equipment (UE), a configuration for a timer to be used by the UE for transmission configuration indicator (TCI) switching; and
generate, for transmission to the UE, or receive, from the UE, an indication of activating or enabling a TCI state, the activating or enabling the TCI state to trigger starting the timer.

45. The one or more non-transitory, computer-readable media of claim 44, wherein the timer is associated with the TCI state, the UE, a physical channel, a component carrier, a cell, or a transmission point.

46. The one or more non-transitory, computer-readable media of claim 44, wherein the TCI state is a first TCI state, and the instructions, when executed, further cause the processor circuitry to:
generate, for transmission to the UE, a list of candidate TCI states; and
receive, from the UE, an indication of a second TCI state to which the UE has switched or will switch, the second TCI state selected from the list of candidate TCI states based on a configuration or an indication.

47. The one or more non-transitory, computer-readable media of claim 44, wherein the instructions, when executed, further cause the processor circuitry to receive, from the UE, a UE capability message to indicate whether the UE is capable of TCI state switching without a measurement of layer 1 (L1) reference signal received power (RSRP).
